(19) United States
(12) Patent Application Publication
(10) Pub. No.: US 2003/0091715 A1
(43) Pub. Date: May 15, 2003

(54) Method and device for making a food product with open-cell internal texture, use for making gluten-free bread

(76) Inventors: Jean-Philippe Girard, Dijon (FR); Jean-Philippe Fasquel, Arc sur Tille (FR); Therese Chalet, Fontaine les Dijon (FR)

Correspondence Address: YOUNG & THOMPSON, 745 SOUTH 23RD STREET 2ND FLOOR, ARLINGTON, VA, 22202

(21) Appl. No.: 10/169,189

(22) PCT Filed: Dec. 28, 2000
(86) PCT No.: PCT/FR00/03710

(30) Foreign Application Priority Data
Dec. 28, 1999 (FR) 99/16582

(51) Int. Cl. A21D 10/00

(52) U.S. Cl. 426/549

(57) ABSTRACT

The invention concerns a method for making food products with open-cell internal texture by baking in an oven a paste conventionally kneaded such as, dough for bread, pizza or the like. The invention is characterized in that it consists at least in preparing said dough without kneading to obtain a viscous paste with low consistency; pressurising it followed by sudden depressurisation through a nozzle adapted to generate a foam which can then be baked in the oven. The invention also concerns a device for implementing said method comprising hoppers (1) and vats (2), a mixer (3), a swelling machine (4) which pressurises the paste before depressurising it through a nozzle (5) and a tunnel oven (8). The invention is useful for making gluten-free bread.

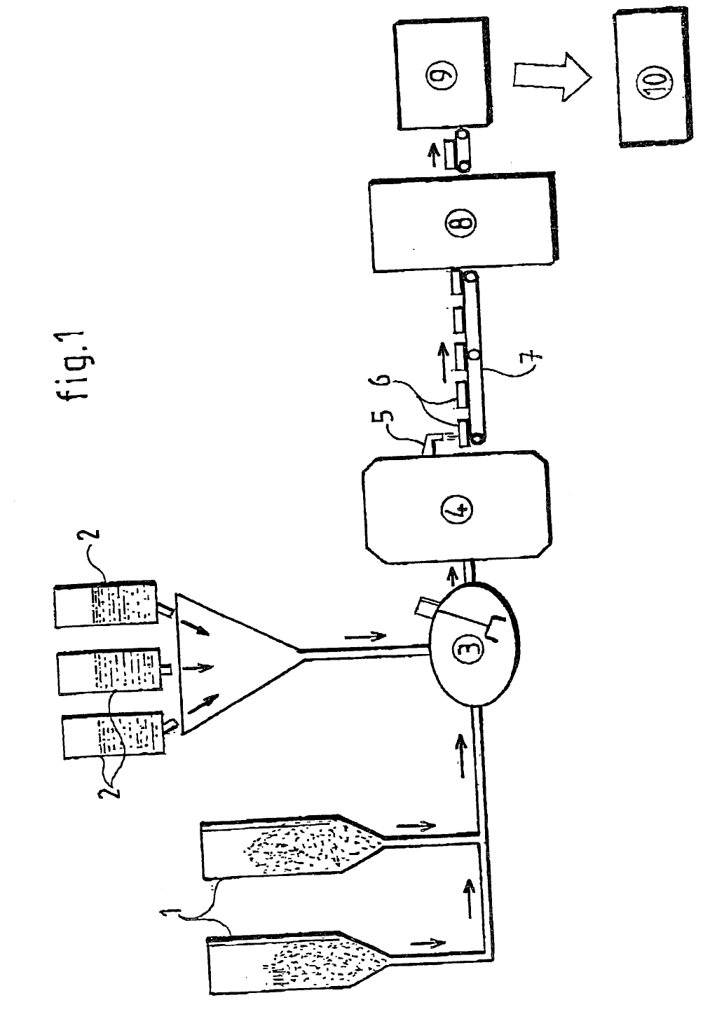

The present invention relates to a method for making food products with open-cell internal texture such as bread, confectionery products or the like, obtained by baking in the oven a liquid dough comprising, or not, a raising agent, yeast or the like, and placed under pressure before a sudden depressurisation through a nozzle to procure for the products a cell-like structure. The method is particulalry adapted for manufacturing bakers' or confectioners' products with open-cell internal texture such as sponge, choux pastry, pizza dough or the like, and more precisely so-called gluten-free “bread”.

The intolerance of persons suffering from celiac disease to gluten is well known; such persons cannot eat food prepared on the basis of flour such as traditional bread, for example. In this respect, it is endeavoured to manufacture substitution products obtained without using flour of certain graminae, which is called gluten-free “bread” by analogy, which presents an internal open-cell structure recalling that of traditional bread crumb.

However, gluten, which is a protein matter naturally present in wheat, rye or like flour, is a vector indispensable for the phenomenon of panification. In effect, gluten plays a preponderant role in the complex process of panification where it makes it possible, in particular, to imprison the gas bubbles produced by the fermentation of the yeast, the leaven or by the gaseous emanation of another raising agent, while the bread dough is rising, procuring, after baking in the oven, a bread crumb with a particularly light cell-like internal structure which singularly characterises bread.

In order to palliate the absence of gluten in substitution bread, it has been sought to replace the traditional wheat flour by potato, corn or like starch, to which are added a thickening agent and an emulsifier to enable the gas bubbles issuing from fermentation of the yeast to be retained and thus create a cell-like internal structure composed of a large number of gaseous cells of small size.

This is, for example, the case of gluten-free bread proposed in French Patent FR 2 765 076 which describes a composition for the preparation of gluten-free bread comprising potato starch and/or rice flour, a thickening agent, an emulsifier, fat, baker's yeast, sugar and salt, obtained by a method, very close to that for manufacturing traditional bread, consisting in mixing all these elements with water, in leaving the dough to rest for the fermentation time, then in proceeding with its baking.

Other compositions for preparing gluten-free bread have also been proposed in order to obtain a uniform open-cell internal structure comprising a large number of gaseous cells; for example, in European Patent 0 642 737, it is question of a composition comprising gluten-free flour, egg and baker's or dried yeast.

These methods for obtaining gluten-free bread which are inspired from the principle of panification of traditional bread, i.e. from the production of the cell-like structure of the crumb by gaseous emanation of the yeast, do not make it possible to obtain a satisfactory cell-like structure of the crumb, with the result that, contrary to traditional bread, loaves are in fact obtained which present a substantially compact appearance.

Furthermore, as there is only a very limited number of manufacturers of gluten-free bread, this product is currently sold by mail-order and it is consumed at best one day after having been manufactured; this results in a lack of freshness which clearly accentuates the impression of compactness of the bread.

Moreover, these methods of manufacture do not allow the persons suffering from celiac disease to prepare confectionery products such as a sponge, choux pastry, a cake or the like, which traditionally need wheat flour, or pizzas which must be prepared just before they are baked.

One of the objects of the invention is to overcome these drawbacks by proposing a method for manufacturing food products procuring an open-cell internal structure recalling that of traditional bread crumb, with or without raising agent, in order to allow fresh gluten-free bread, which presents all the physical and organoleptic characteristics of traditional bread, to be prepared.

In this respect, the method for manufacturing food products with open-cell internal structure obtained by baking in the oven a dough conventionally kneaded and presenting a high consistency such as for example bread dough, pizza dough or the like, is noteworthy in that it consists at least in preparing said dough without kneading in order to obtain a viscous dough with low consistency, i.e. runny, then in pressurising it in a recipient provided to that end, then in depressurising it suddenly through a nozzle adapted to create a foam comprising a cell-like internal structure which can then be baked in the oven advantageously in the presence of steam.

It will be understood that the open-cell internal structure results no longer from the gases issuing from fermentation of the yeast, but from the depressurisation of the dough through the nozzle, i.e. it is obtained by a mechanical process and no longer by a chemical process as previously.

Another object of the invention concerns a device, implementing the method, for making a food product of open-cell internal structure obtained by baking in the oven a conventionally kneaded dough presenting a high consistency, such as for example bread dough, pizza dough or the like; this device is noteworthy in that it comprises at least hoppers and vats respectively containing the solid and liquid raw materials of the product, a mixer for forming a homogeneous dough of low consistency, a swelling machine which pressurises the dough with an internal gas before depressurising it through a nozzle to create a product of cell-like internal structure advantageously positioned in a mould, a tunnel oven for baking said product and a cooling tunnel for cooling it before it is packed.

Other advantages and characteristics will appear more readily from the description which will be given by way of non-limiting example of the method according to the invention and of a device carrying out said method, with reference to the single FIGURE of the accompanying drawing showing a general schematic representation of the device according to the invention.

The method consists in preparing the dough without kneading in order to obtain a viscous dough of low consistency, then in pressurising it in a recipient provided to that end, then in depressurising it suddenly through a nozzle in order to create a foam comprising a cell-like internal structure which is then baked in the oven.

In this way, the method according to the invention makes it possible, in particular, to manufacture food products with open-cell internal structure with or without raising agent and advantageously continuously, contrary to the prior art. Where a long step of kneading then of rest of the dough are necessary for the fermentation which, as has been said, is responsible for the open-cell internal structure.

Furthermore, the usual step of baking of the dough thus obtained consists in a complete baking at around 200° C. for about thirty minutes until a crust is obtained, and even in a partial baking, i.e. a baking at more than 200° C. for about ten minutes to produce a pre-cooked product, deep-frozen or not, of which the baking will advantageously be finalized at the point of sale or consumption.

The preparation of the dough consists in the mixture of a “mix”, i.e. a composition comprising one or, more ingredients pre-mixed and pre-dosed depending on the product which it is desired to make, with water in such proportions that the dough presents a viscosity allowing it to flow through the nozzle. The mixture of the “mix” with water is advantageously effected mechanically at slow speed, i.e. with a slow speed of rotation of the arm of the mixer, with the result that said mixture does not foam, until complete homogenisation of the mixture.

The proportion of water mixed with the “mix” which determines the viscosity of the dough depends in particular on the pressurising of said dough as well as on the dimensions of the nozzle in which it must flow upon depressurisation thereof. Furthermore, the size of the cells of the internal structure of the products depends directly on the viscosity, on the pressure exerted on the dough as well as on the dimensions and shape of the nozzle.

In order to obtain a runny dough of adequate viscosity to allow its passage through a nozzle whose section is of the order of some millimeters diameter, the water is advantageously mixed with the “mix” in a proportion of at least 1 kilo of water per kilo of “mix”. The person skilled in the art knows how to determine with precision the quantity of water necessary for obtaining an adequate viscosity as a function of the different parameters which are, in addition to the physical and chemical properties of the ingredients, the pressure of confinement, the dimensions and the shape of the nozzle.

According to a preferred variant embodiment of the invention, the step of pressurisation of the dough consists in confining said dough in an aerosol which offers a particularly advantageous packaging of the product: in effect, the latter is ready for use and the consumer will merely have to exert a pressure on the valve of the aerosol to obtain a foam which he/she will then place in a recipient before baking it in a traditional oven or in a micro-wave oven in order, finally, to obtain a fresh product with open-cell internal structure. In this particular embodiment, the dough is pressurised to a pressure substantially included between 5 and 15 bars depending on the viscosity of the dough and the size of the cells which it is desired to obtain in the final product. In effect, the cells of a sponge, of choux pastry or of a fruit cake, do not have the same dimensions, and it is consequently necessary to adapt the pressure of the propellant gas as a function of the texture of the product desired. The propellant gas of the aerosol is preferably nitrogen protoxide currently used in the domain of the farm-produce industry for its chemical stability and its neutrality, particularly from the organoleptic standpoint, but carbon dioxide might be used in the same way; however, the latter presents the drawback of acidifying the dough and consequently modifying its organoleptic and physical characteristics.

It goes without saying that the propellant gas may also be nitrogen, although expensive, or air which, however, presents the drawback of oxidising the fats.

In order to make a satisfactory gluten-free product with open-cell internal structure, such as a sponge, choux pastry, a fruit cake, bread or the like, the “mix” comprises at least cornflour and/or potato starch and/or rice flour and/or the like, a swelling agent, i.e. an agent which increases the volume of the final product such as egg white for example, and one or more thickening agents. Furthermore, the “mix” advantageously comprises an aromatic agent and/or a colouring agent for the gluten-free product to present a texture, an appearance and organoleptic characteristics similar to the traditional product.

It goes without saying that the “mix” can also comprise a conserving agent in order that the qualities of the product be conserved in time.

According to a particularly advantageous variant embodiment, the “mix” comprises so-called baker's yeast or dried yeast or the like, in order to create, by fermentation of the baker's yeast or by gaseous emanation of the dried yeast, internal cells added to the cells obtained by the pressure reduction of the dough through a nozzle normally identical to the preceding one, with the result that a finished product is obtained which presents a greater volume and comprises a less uniform cell-like internal structure. In effect, during baking in the oven, a gaseous pressure induced by the yeast increases the volume of the final product, rendering the cells in its internal structure irregular; moreover, for making gluten-free bread, the use of a so-called baker's yeast gives said bread an aroma of natural yeast recalling the aromas of traditional bread.

Good results were obtained for making gluten-free bread by using the “mix” compositions described in Examples 1 and 2 set forth hereinafter.

| Example 1: | | |
|---|---|---|
| corn starch | 582 | g |
| egg white | 288 | g |
| rice flour | 60 | g |
| vegetable fat | 20 | g |
| milk powder | 17 | g |
| salt | 12 | g |
| thickening agent E440 | 9 | g |
| sugar | 8 | g |
| conserving agent E200 | 4 | g |
| Example 2: | | |
| potato starch | 559 | g |
| egg white | 288 | g |
| rice flour | 60 | g |
| dried yeast | 22 | g |
| vegetable fat | 20 | g |
| milk powder | 17 | g |
| salt | 12 | g |
| thickening agent E440 | 9 | g |
| aroma | 6 | g |
| sugar | 3 | g |
| conserving agent E200 | 4 | g |

The “mixes” of Examples 1 and 2 are respectively mixed with water in order to obtain a dough whose viscosity is about 650 centipoises at 25° C., or 1850 centipoises at 4° C., before being confined in an aerosol under pressure of about 10 bars of a propellant gas, preferably nitrogen protoxide.

It goes without saying that the addition of water may be reduced in order to obtain a dough of higher viscosity by choosing a higher pressure of the propellant gas.

After depressurisation of the doughs through the nozzles of the respective aerosols and baking in the oven in the presence of steam, two loaves of bread are respectively obtained of which the final volume is comparable and of which only the internal structure differs. In effect, the gluten-free bread obtained from the “mix” of Example 1, i.e. without raising agent, presents a crumb of substantially uniform structure recalling the crumb of traditional bread, while the crumb of the bread obtained from the “mix” of Example 2 comprises, due to the presence of yeast, more cells of large diameter which render it less uniform.

Furthermore, baking in the oven is advantageously effected in the presence of steam in order to obtain satisfactory organoleptic and physical characteristics and the person skilled in the art will easily adapt the temperature as well as the baking time as a function of the final product sought and possibly of the type of equipment used.

In order advantageously to make products of cell-like internal structure with or without raising agent, continuously, the device comprises, with reference to the single FIGURE, hoppers 1 containing the solid raw materials such as for example the wheat- or cornflour or the like, the yeast, the milk powder, etc . . . , and vats 2 containing the liquid raw materials such as the water, the fat or the egg white for example. The raw materials are dosed, depending on the proportions of the composition of the dough of the desired product, by means of conventional dosers then introduced in a mixer 3 in order to form a homogeneous dough of low consistency. This dough is then transported by a hydraulic circuit, for example, up to a swelling machine 4. Said swelling machine 4 pressurises the dough with an inert gas such as nitrogen protoxide, carbon dioxide or the like, to a pressure of at least 5 bars; then the dough/pressurised inert gas mixture is depressurised through a nozzle 5 in order to create a foam with cell-like internal structure. The foam is then collected in moulds 6 advantageously positioned on a conveyor 7 for it to be finally baked in a tunnel oven 8. The product thus obtained is then conventionally cooled in a cooling tunnel 9 then wrapped and packaged in a machine 10 provided to that end.

It is obvious that the method according to the invention may advantageously be applied to the manufacture of traditional bread, i.e. from flour of graminae, with or without raising agent, and to all bakers' and confectioners' preparations with open-cell internal structure.

Finally, it goes without saying that the method for manufacturing a product with open-cell internal structure may be adapted in particular to all bakers' or confectioners' products such as sponges, choux pastry, fruit cake, pizza dough or the like, and that the Examples which have just been given are only particular illustrations, in no way limiting, of the domains of application of the invention.

1. Method for making a food product with open-cell internal structure obtained by baking in the oven a conventionally kneaded dough presenting a high consistency such as, for example bread dough, pizza dough or the like, characterized in that it carries out at least the following steps:
a) preparing said dough without kneading in order to obtain a viscous dough with low consistency, i.e. runny, then
b) pressurising it in a recipient provided to that end, then
c) depressurising it suddenly through a nozzle adapted to create a foam comprising a cell-like internal structure and, finally,
d) baking in the oven advantageously in the presence of steam.

2. Method according to the preceding claim, characterized in that the preparation of the dough consists in the mixture of a “mix”, i.e. a pre-mixed and pre-dosed composition, with water in proportions such that the dough presents a viscosity allowing it to flow through the nozzle.

3. Method according to claim 2, characterized in that the water is mixed with the “mix” in a proportion of at least 1 kilo of water per kilo of “mix”.

4. Method according to any one of the preceding claims, characterized in that the pressurising of the dough consists in confining it in an aerosol.

5. Method according to claim 4, characterized in that a gas under pressure of at leaxt 5 bars is used in the aerosol.

6. Method according to claim 5, characterized in that nitrogen protoxide is used as pressurised gas.

7. Device for making a food product with open-cell internal structure obtained by baking in the oven a conventionally kneaded dough presenting a high consistency such as for example bread dough, pizza dough or the like, carrying out the method according to any one of claims 1 to 3, characterized in that it comprises at least hoppers (1) and vats (2) respectively containing the solid and liquid raw materials of the product, a mixer (3) for forming a homogeneous dough of low consistency, a swelling machine (4) which pressurises the dough with an inert gas before depressurising it through a nozzle (5) to create a product of cell-like internal structure advantageously positioned in a mould (6), a tunnel oven (8) for baking said product and a cooling tunnel (9) for cooling it before it is packed.

8. Food product with open-cell internal structure obtained by the method according to any one of claims 1 to 6 from a conventionally kneaded dough presenting a high consistency such as for example bread dough, pizza dough or the like, characterized in that the composition of the dough or of the “mix” comprises at least the following ingredients:
cornflour and/or potato starch and/or rice flour and/or the like,
a swelling agent,
mixed with water in the proportion of at least one kilo of water per kilo of “mix”.

9. Food product according to claim 8, characterized in that the composition of the dough or of the “mix” comprises one or more thickening agents.

10. Food product according to either one of claims 8 and 9, characterized in that the dough or the “mix” comprises so-called baker's yeast, dried yeast or the like, to obtain a less uniform cell-like internal structure of the crumb.

11. Application of the food product with open-cell internal structure, according to one or the other of claims 8 or 9, to gluten-free bread comprising at least the following ingredients:
corn starch,
egg white,
thickening agent,
dried yeast,
fat,
milk powder,
salt,
conserving agent, and
sugar.
